(19) United States
(12) Patent Application Publication
(10) Pub. No.: US 2017/0287467 A1
(43) Pub. Date: Oct. 5, 2017

(54) SYSTEM FOR SEGREGATING AUDIO MESSAGES IN A COCKPIT

(71) Applicant: THALES, Courbevoie (FR)

(72) Inventors: Stephanie LAFON, Martignas Sur Jalle (FR); Alexiane Bailly, Marcheprime (FR); Francois Michel, Merignac (FR)

(21) Appl. No.: 15/475,056

(22) Filed: Mar. 30, 2017

(30) Foreign Application Priority Data
Apr. 1, 2016 (FR) 1600548

(51) Int. Cl. G10L 15/04; G10L 25/48; G06F 17/30; G10L 15/08

(52) U.S. Cl. CPC G10L 15/04; G10L 15/08; G10L 25/48; G06F 17/30743; G10L 2015/088

(57) ABSTRACT

The general field of the invention is that of systems for segregating audio messages in a cockpit of a first aircraft. Said system comprises:
means for receiving and recording audio messages;
a database of keywords for the audio messages;
means for recognizing of keywords in the audio messages;
means for separating the audio messages as a function of said keywords;
means for ranking the messages according to an order of priority;
means for processing the audio messages according to said order of priority;
means for transmitting the messages processed according to said order of priority;
means for listening to the audio messages.

The field of the invention is that of human-machine interfaces within aircraft cockpits, and more particularly sound interfaces required for communication inside cockpits.

At the present time, in aeroplane cockpits, sound interfaces may be broadcast by the pilots' headsets or by the cockpit loudspeakers. The sounds that are broadcast are numerous and of various types. These comprise audible warnings, audio messages originating from air traffic control (ATC), the automatic terminal information service (ATIS), the pilots themselves, cabin crew, mechanics, etc.

Audio message is understood to mean that part of the audio stream that has a meaning. For example, an instruction from the controller sent on the ATC frequency is an audio message. The problem is that these various reception channels broadcast audio streams that are merged and broadcast by the headset loudspeakers as a single stereo sound. It is difficult for the pilots to focus on a message without being distracted by those that are broadcast at the same time. In this context, some warnings or some flight instructions may be misinterpreted or ignored. It is also difficult to know who is broadcasting the message.

In the aeronautical field, to mitigate this problem, physical control panels such as the audio control panel (ACP) or the radio management panel (RMP) make it possible to select the reception channels and to manage the sound level of each of them.

In the aeronautical field, these control panels are not completely satisfactory because segregation requires intervention by the pilot and remains unchanged once it has been adjusted. Moreover, this segregation is performed between various audio streams and not within the same stream. Finally, it is based solely on volume adjustment.

In the consumer field, a novel technological solution is emerging. It is based on the spatialization of sound. This technique is growing in particular for home cinema. On its own, it does not provide a solution that meets the operational needs of pilots and that is compatible with current avionic systems.

The system for listening to audio messages according to the invention does not exhibit the abovementioned drawbacks. It is an intelligent system for listening to and processing information contained in audio messages. It also makes it possible to reproduce information adapted to the needs of the operator. It makes it possible to ensure that audio messages are selected according to their importance by means of simple criteria.

More precisely, the invention relates to a system for segregating audio messages in a cockpit of a first aircraft, said system comprising means for receiving and recording said audio messages, a database of keywords for said audio messages, and means for listening to said audio messages,
characterized in that the system comprises:
a first computer having the functions of recognizing keywords in said audio messages and separating said audio messages as a function of said keywords,
a second computer having the functions of ranking said messages according to an order of priority and processing said audio messages according to said order of priority, and;
means for transmitting said processed messages to the listening means according to said order of priority.

Advantageously, the keywords are aircraft call signs.

Advantageously, the system comprises means for graphically representing and means for displaying audio messages.

Advantageously, the processing of an audio message consists in an adaptation of its sound level.

Advantageously, the processing of an audio message consists in a spatialization of the sound of said audio message.

Advantageously, the processing of an audio message consists in a modification of the voice reading said audio message.

Advantageously, the first priority is assigned to the audio messages whose call sign is that of the first aircraft.

Advantageously, the order of the priorities of the audio messages is a function of the distance or the attitude or the trajectory of second aircraft close to the first aircraft, said second aircraft being identified by the call signs of their audio messages.

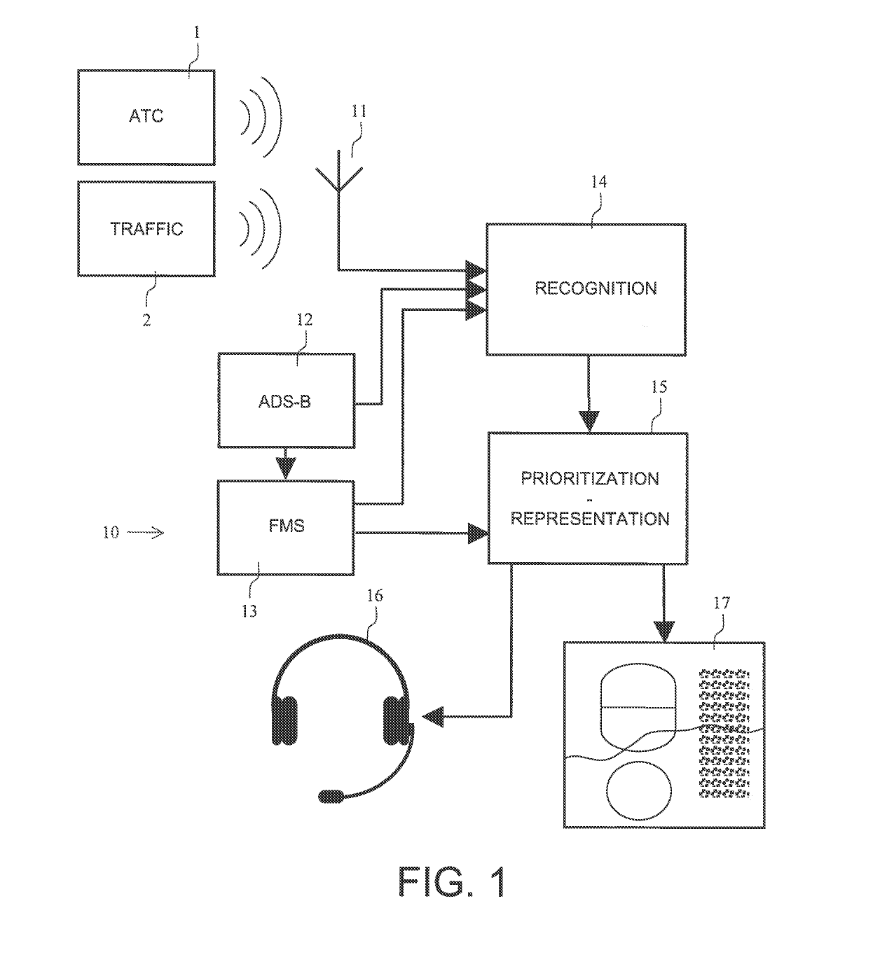

The invention will be better understood and other advantages will emerge upon reading the following description, given in a non-limiting manner, and by virtue of the appended FIG. 1, which shows the general synopsis of the system for segregating audio messages according to the invention.

By way of non-limiting example, FIG. 1 shows the general synopsis of a system 10 for segregating audio messages according to the invention. This system 10 comprises:
Means for receiving 11 audio signals;
One or more databases 12 and 13;
A first computer 14;
A second computer 15;
Means for listening 16 or displaying 17.

The receiving means 11 capture the audio signals coming from outside the plane or from inside the plane. The external signals have various origins. They may originate from air traffic control (ATC) 1 or the automatic terminal information service (ATIS) 2, The receiver elements therefore consist of receiving antennae. The internal signals may come from the pilots themselves or from cabin crew. Reception is provided by microphones. These receiving means are symbolized by a single antenna 11 in FIG. 1.

One or more databases 12 and 13 contain at least the call signs or identifier of the aircraft, as well as keywords specific to aeronautical exchanges. Call signs are also known as tags. The call sign of the carrier is provided by the flight management system (FMS) 13, and the identifiers of other planes are provided by the automatic dependent surveillance—broadcast (ADS-B) system 12.

All of the information originating from the receiving means 11 and the databases 12 and 13 is processed by a computer or a processor 14, which provides the following functions:
Storing the received audio signals;
identifying keywords in the received signals. These keywords belong, inter alia, to ATC/pilot phraseology. Thus, the system divides the audio stream into sub-messages, each intended for a given contact. Moreover, these keywords contain the identifiers. In the great majority of cases, an aeronautical message starts or finishes with the identifier of the broadcaster, which facilitates detection thereof;
Dividing the audio signals by recognized identifier into audio sub-messages.

The audio sub-messages are sent to a second computer 15, whose functions are essentially:
Ranking the messages according to an order of priority dependent on the identifier. Conventionally, the first priority is assigned to the audio messages whose call sign is that of the aircraft itself. Next, the order of the priorities of the audio messages may be a function of the distance or the attitude or the trajectory of second aircraft close to the aircraft, these second aircraft being identified by the call signs of their audio messages. It is important to take these various parameters into consideration in so far as, in flight, an aeroplane may be close to the carrier but move away therefrom. In the same way, in an airport, an aeroplane may be close to the carrier but be situated on a parallel taxiway.
Processing the audio messages as a function of their order of priority. The processing operations may be purely audio.
Storing the processed messages for later listening.

The simplest processing operation consists in keeping only the most important messages and deleting the others. A second processing operation consists in increasing the sound of the most important messages or lowering the volume of those messages considered to be secondary. A third processing operation consists in modifying the tone of the messages.

Finally, a last processing operation consists in spatializing the sound, that is to say in creating the illusion that the audio message is coming from a determined direction. For example, when the sound is sent in an audio headset comprising two earphones, the messages sent in the two earphones may be offset slightly in terms of time or intensity or frequency in order to create this illusion. The most important audio messages may thus appear to come from a preferred position, for example in front of or in the vicinity of the receiver, while the least important messages come from a secondary position, behind or to the side of or at a distance from the receiver. This spatialization of sound makes it possible for the receiver to focus his attention better on a given source. This effect is termed the ‘cocktail party’ effect.

When the audio headset is equipped with a system for detecting position or attitude, the headset attitude information may be used so as to make the spatialization independent of the headset position. The sound origin of the message thus appears fixed in space.

The processing operations may also be graphical. The audio message is transcribed in the form of text and then subsequently sent to the display devices in the plane. The audio and graphical processing operations may be implemented separately or simultaneously, some messages being intended to be read and others to be heard.

The various signal processing operations described above are easily accessible to a person skilled in the art.

Once formatted, the messages are sent either to the listening means 16 in the plane or to the various display devices in the plane. The main listening means, as shown in FIG. 1, is the audio headset of the crew members. There are also loudspeakers in the cockpit.

The various display devices comprise large dashboard display screens, what are termed ‘head-up’ display systems, and headset or head display systems.

1. System for segregating audio messages in a cockpit of a first aircraft, said system comprising means for receiving and recording said audio messages, a database of keywords for said audio messages, and means for listening to said audio messages,
wherein the system comprises:
a first computer having the functions of recognizing keywords in said audio messages and separating said audio messages as a function of said keywords,
a second computer having the functions of ranking said messages according to an order of priority and processing said audio messages according to said order of priority, and;
means for transmitting said processed messages to the listening means according to said order of priority, the order of the priorities of the audio messages being a function of the distance or the attitude or the trajectory of second aircraft close to the first aircraft, said second aircraft being identified by the call signs of their audio messages.

2. System for segregating audio messages according to claim 1, wherein the keywords are aircraft call signs.

3. System for segregating audio messages according to claim 1, wherein the system comprises means for graphically representing and means for displaying audio messages.

4. System for segregating audio messages according to claim 1, wherein the processing of an audio message consists in an adaptation of its sound level.

5. System for segregating audio messages according to claim 1, wherein the processing of an audio message consists in a spatialization of the sound of said audio message.

6. System for segregating audio messages according to claim 1, wherein the processing of an audio message consists in a modification of the voice reading said audio message.

7. System for segregating audio messages according to claim 1, wherein the first priority is assigned to the audio messages whose call sign is that of the first aircraft.
